(19) United States
(12) Patent Application Publication
(10) Pub. No.: US 2006/0070097 A1
(43) Pub. Date: Mar. 30, 2006

(54) Data distribution system and data distribution method

(76) Inventor: Mitsumasa Etoh, Tokyo (JP)

Correspondence Address: LADAS & PARRY LLP, 224 SOUTH MICHIGAN AVENUE, SUITE 1600, CHICAGO, IL, 60604, US

(21) Appl. No.: 10/529,928

(22) PCT Filed: Oct. 8, 2002
(86) PCT No.: PCT/JP02/10442

§ 371 Date: Apr. 1, 2005

(51) Int. Cl. H04N 5/445; G06F 13/00

(52) U.S. Cl. 725/37

(57) ABSTRACT

This invention provides a data distribution system and data distribution method that make it possible to watch the contents of a sports competition when desired, and to watch desired scenes of the sports competition. Scenario data containing basic data, pre-pitch data, pitch data and results data are distributed from a data-distribution apparatus 10 to a terminal 20, where the terminal 20 creates CG based on the received scenario data and stored CG data to reproduce the game. Also, when there is code contained in the pre-pitch data, pitch data and results data indicating a special scenario, the terminal 20 creates CG based on CG data received with the scenario data to reproduce the competition.

### BACKGROUND OF THE INVENTION

1. Field of the Invention

This invention relates to a data distribution system and data distribution method of distributing data via a communications network, and more particularly to a data distribution system and data distribution method of distributing sports competition contents.

2. Description of the Related Art

Conventionally, contents of sports competitions or games such as baseball, soccer or the like have been broadcast as images by ground-wave television, satellite television, cable television, etc. Also, the broadcast time and broadcast contents depend on the compilation and editing by a television station.

However, in the prior technology there are problems in that since the broadcast time of the sports competition or game is decided by the television station, it is not possible to watch the game when desired, and since the broadcast contents of the sports game are decided by editing of the television station, it is not possible to watch desired scenes.

Taking these problems into consideration, it is the object of this invention to provide a data distribution system and data distribution method that make it possible to watch a sports competition or game when desired, and make it possible to watch a desired scene of a sports competition or game.

### SUMMARY OF THE INVENTION

This invention is constructed as described below in order to solve the problems mentioned above.

The data distribution system of this invention is a data distribution system that distributes sports competition contents from a data-distribution apparatus to a terminal via a communications network, where the data-distribution apparatus comprises: a competition-progression-input means of inputting the progression of the sports competition, a scenario-data-creation means of creating scenario data that shows the progression of the sports competition based on input from the competition-progression-input means, a scenario-data-memory means of storing the scenario data created by the scenario-data-creation means, and a scenario-data-distribution means of distributing the scenario data stored in the scenario-data-memory means to a terminal via a communications network, and where the terminal reproduces the sports competition contents as images based on pre-stored image data and scenario data.

The terminal can also be such that it reproduces sports competition contents as CG based on CG data, which are stored as the pre-stored image data, and scenario data.

Also, the data-distribution apparatus comprises: a special-scenario-data-registration means of registering unimagined conditions as special scenario data in the scenario data, and a special-image-data-creation means of creating image data that correspond to the special scenario, and where the scenario-data-distribution means can distribute the image data created by the special-image-data-creation means together with the scenario data when there is a special scenario when distributing the scenario data.

Moreover, the data distribution method of this invention is a data distribution method of distributing the contents of a sports competition or game from a data-distribution apparatus to a terminal via a communications networks, and where the data-distribution apparatus creates scenario data showing the progression of the sports competition based on the input progression of the sports competition, stores in memory the created scenario data, and distributes the stored scenario data to a terminal via a communications network, and where the terminal reproduces the sports competition contents as images based on pre-stored image data and the scenario data.

Also, the terminal can also reproduce the sports competition contents as CG based on CG data, which are stored as the pre-stored image data, and the scenario data.

Also, the data-distribution apparatus can register unimagined conditions as special scenario in the scenario data, create image data corresponding to the special scenarios, and distribute the created image data together with the scenario data when there is a special scenario included when distributing the scenario data.

Moreover, the memory medium of this invention is a memory medium that stores the scenario data that are distributed by the data distribution system from the data-distribution apparatus to a terminal as described in any of the claims 1 to 3.

Furthermore, this data distribution method of distributing the contents of sports competitions or games can also distribute image data related to the progression of the sports competition, scenario data that shows the progression of the sports competition, and a program that sequentially switches and displays the image data according to the scenario data.

The present invention is not limited by the embodiments described above, and it is evident that each of the embodiments can be suitably changed within technical range of the invention. Also, the number, location and form of the components described above are not limited to the embodiments mentioned above, and any suitable number, location or shape is possible in implementing the invention. In the drawings, the same code numbers are used for identical components and elements.

### BRIEF DESCRITPION OF THE DRAWINGS

FIG. 1 is a block diagram showing the construction of an embodiment of the data distribution system of the invention.

FIG. 2 is a drawing showing an example of the basic data, data before a pitch, and pitch data that are input from the input unit shown in FIG. 1.

FIG. 3 is a drawing showing an example of the scenario data created by the scenario-creation unit shown in FIG. 1.

FIG. 4 is a flowchart for explaining the operation of creating scenario data in an embodiment of the data distribution system of the invention.

FIG. 5 is a flowchart for explaining the operation of searching for and distributing scenario data in an embodiment of the data distribution system of the invention.

FIG. 6 is a drawing showing the relationship between the data-distribution apparatus and the terminal in an embodiment of the data distribution system of the invention.

FIG. 7 is a drawing showing an example of the display screen that is displayed on the terminal shown in FIG. 1.

### DESCRIPTION OF THE PREFERRED EMBODIMENTS

An embodiment of the invention is explained below.

The embodiment of the invention will be explained in detail based on the drawings.

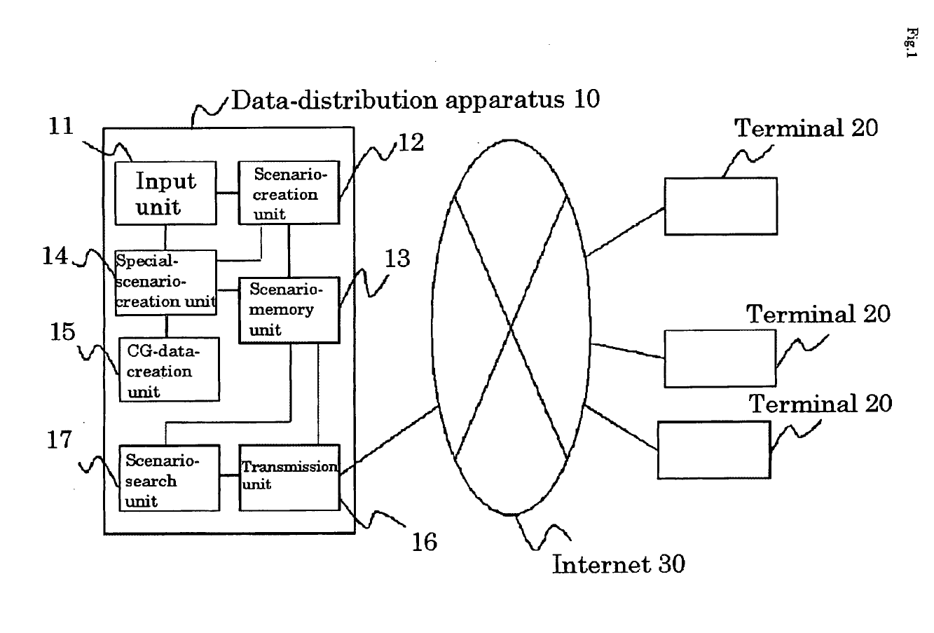

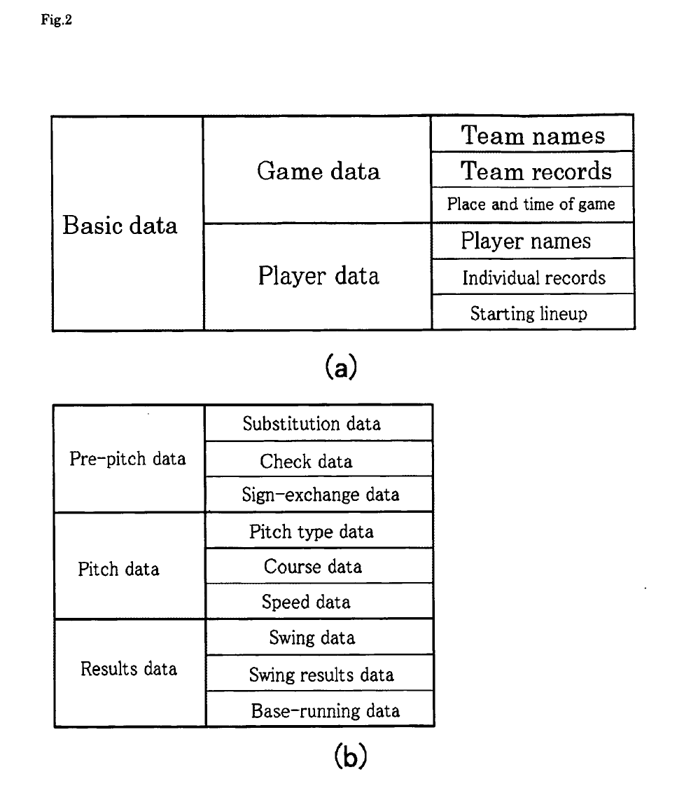

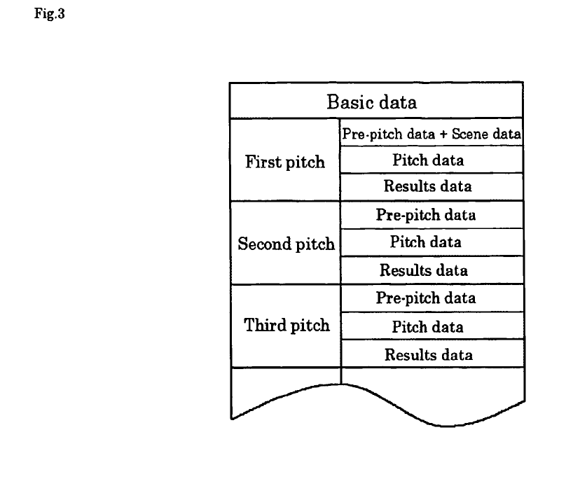

FIG. 1 is a block diagram showing the construction of an embodiment of the data distribution system of the invention, FIG. 2 is a drawing showing an example of the basic data, data before a pitch, and pitch data that are input from the input unit shown in FIG. 1, and FIG. 3 is a drawing showing an example of the scenario data created by the scenario-creation unit shown in FIG. 1.

This invention is applied to the distribution of contents of various sports competitions or games, however in this embodiment, distribution of the contents of a baseball game is explained.

The data distribution system of this embodiment comprises a data-distribution apparatus 10 and terminal 20 that are connected via a communications network or the Internet 30, and it distributes scenario data, or in other words, contents of a baseball game from the data-distribution apparatus 10 to a terminal 20, which is set up in a normal home or the like, over the Internet 30.

The data-distribution apparatus 10 comprises: an input unit 11, scenario-creation unit 12, scenario-memory unit 13, special-scenario-creation unit 14, CG (Computer Graphics) data-creation unit 15, transmission unit 16 and scenario-search unit 17

The input unit 11 is an input means such as a keyboard, and it is used to input game data, based on the display of a display means such as a display (not shown in the figure), that give the team names, team records and the place and time of the game as shown n FIG. 2(a), and basic data that contains player information that gives the player names, individual records and starting lineups, and, as shown in FIG. 2(b), it is also used to input result data for each pitch such as pre-pitch data that includes substitution data, checking data and sign-exchange data, pitch data that includes the type of pitch, course data and speed data, and results data that include swing data, swing-results data and base-running data.

When entering the pre-pitch data, pitch data and results data, there are a plurality of pre-registered patterns, and the input unit 11 is used to select a pattern from the plurality of registered patterns that matches the game contents. For example, when entering the swing data of the results data, there is a plurality of pre-registered patterns such as ‘bunt’, ‘full swing’, ‘normal swing’, ‘half swing’ or the like, and the swing data that matches the game contents is selected from among these patterns.

Also, where there aren't any patterns in the registered patterns that match the game contents, the input unit 11 is used to perform input indicating that it is a special scenario, and data are input for created CG data that correspond to the input special scenario.

Substitution data is information that indicates player substitutions such as a pinch hitter or pinch runner, and check data is information that indicates whether or not a pick-off attempt was made and the number of times, sign-exchange data is information that indicates the time required for a sign exchange and the conditions at the time of the sign exchange.

Pitch-type data are information that indicates the type of pitch the pitcher threw, such as straight, curve, etc., course data is information that indicates the course of the ball thrown by the pitcher (includes information that indicates whether or not it was a strike), and speed data is information that indicates the speed of the ball thrown by the pitcher.

Swing data is information that indicates whether or not the batter swung and the strength of the swing, swing-results data is information that indicates the results after the swing such as a strike, hit up the middle, third-base grounder, etc., and the base-running data is information that indicates the advancement of the batter and runners.

The scenario-creation unit 12 creates scene information, based on basic data, pre-pitch data, pitch data and results data that were input from the input unit 11, that shows batter, runners and fielders, and together with adding changes in the batter, runners and fielders to the pre-pitch data, it creates scenario data for each game as shown in FIG. 3 from the basic data, pre-pitch data, pitch data and results data, and stores it in the scenario-memory unit 13.

The scene data is added to the pre-pitch data when there were changes in the batter, runners or fielders, or in other words when there was a change such as a change in batters, and it shows the batter, runners and fielders after a change, such as a batter is made.

The scenario-memory unit 13 is a memory means such as a hard disk and stores the scenario data created by the scenario-creation unit 12.

The special-scenario-creation unit 14 transfers data for creating CG data, which correspond to the special scenario that was input from the input unit 11 when there was input to the input unit 11 indicating a special scenario, to the CG-data-creation unit 15, and together with giving instructions to create CG data corresponding to the special scenario, it adds code to the pre-pitch data, pitch data or results data indicating that there is a special scenario, and stores the CD data created by the CG-data-creation unit 15 in the scenario-memory unit 13. When the scenario-creation unit 12 stores scenario data in the scenario-memory unit 13, the CC data that were created by the CG-data-creation unit 15 has code indicating that it is a special scenario. Things that can be considered to be a special scenario include, unimagined odd plays, big homerun, a fine play, etc., and it is input from the input unit 11 for creating CG data such as the batter's location, the pitcher's movement, etc.

The CC-data-creation unit 15 creates CG data that corresponds to the special scenario based on information for creating CG data that corresponds to the special scenario input from the input unit 11.

The transmission unit 16 received search data that was sent from the terminal 20 via the Internet 30, and together with transferring it to the scenario-search unit 17, it sends the scenario data that is stored in the scenario-memory unit 13 to the terminal 20 via the Internet 30.

The scenario-search unit 17 searches for scenario data stored in the scenario-memory unit 13 based on the search data send from the terminal 20 via the Internet, and sends the searched scenario data to the terminal 20 by way of the transmission unit 16.

The terminal 20 is an apparatus such as a personal computer or game machine that can reproduce CG data, and it has a function for sending search data for searching for scenario data to the data-distribution apparatus 10, a function for storing in memory CG data that corresponds to the scenario data created by the data-distribution apparatus 10 and a function for creating CG based on the scenario data send from the data-distribution apparatus 10 and the stored CG data.

The CG data corresponding to the scenario data are data for expressing the baseball stadium where the game is taking place, the players, the pitching operation, the fielding operation and batting operation using CG, and it is possible to display the each of the patterns that were selected when entering the pre-pitch data, pitch data and results data as CG.

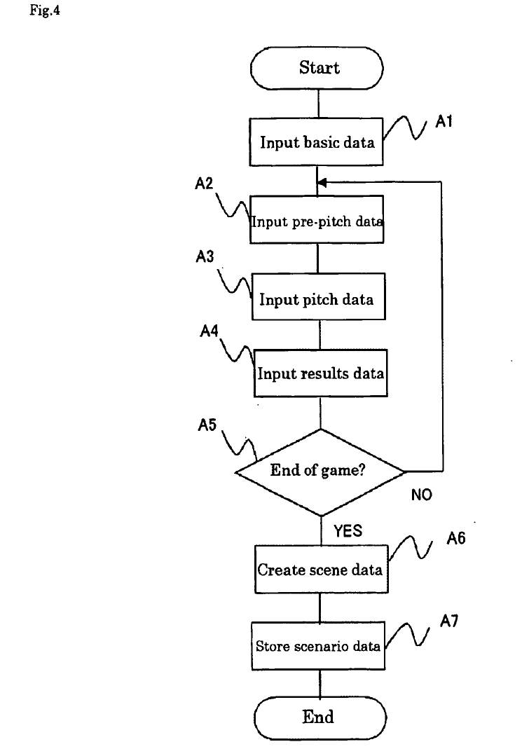

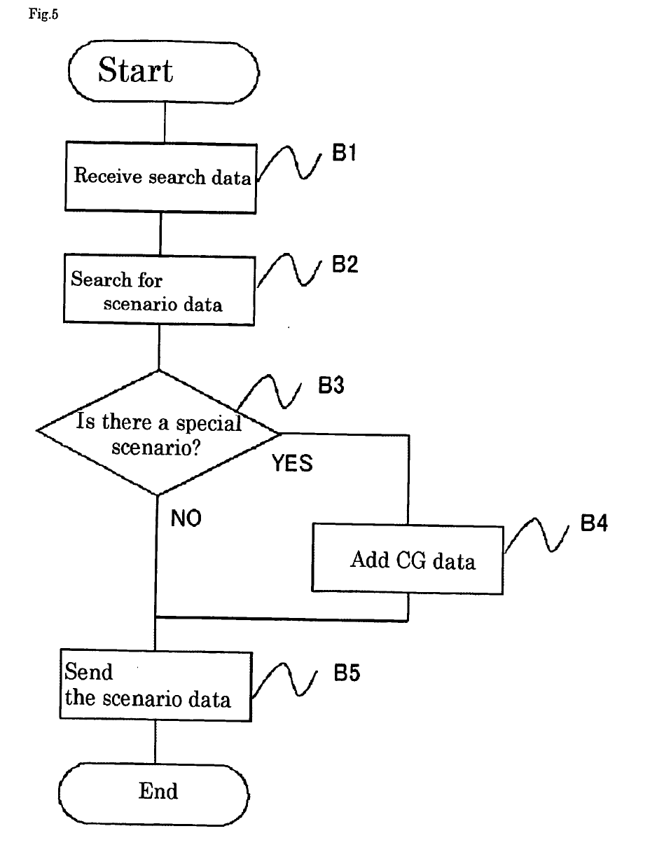

Next, the operation of the embodiment will be explained in detail with reference to FIG. 4 and FIG. 5.

FIG. 4 is a flowchart for explaining the operation of creating scenario data in an embodiment of the data distribution system of the invention, and FIG. 5 is a flowchart for explaining the operation of searching for and distributing scenario data in an embodiment of the data distribution system of the invention.

First, the operation of creating scenario data will be explained.

Game information indicating the competing team names, team records and game location and time, and basic information indicating the player names, individual records and starting lineups are entered from the input unit 11 (A1).

Next, pre-pitch data, which includes substitution data, check data and sign-exchange data corresponding to the first pitch, are entered (A2), pitch data, which includes pitch type data and course data, are entered (A3), and results data, which include swing data, swing results data and base-running data, are entered (A4).

When there is input from the input unit 11 indicating a special scenario, the special-scenario-creation unit 14 transfers information for creating CG that corresponds to the special scenario entered from the input unit 11 to the CG-data-creation unit 15, and together with giving instructions to create CG data corresponding to the special scenario, adds code, indicating a special scenario, to the pre-pitch data, pitch data and results data.

After entering the results data in step A4, it is determined whether or not the game has ended (A5), and in the case that the game has not ended, the process returns to step A2 and input for the next pitch is performed; however, in the case that the game has ended, the scenario-creation unit 12 creates scene data that indicates the batter, runners and fielders based on the basic data, pre-pitch data, pitch data and results data (A6), and adds the scene data to the pre-pitch data when there are changes in the batter, runners or fielders, or in other words when substitutions such as a batter are made.

Next, the scenario-creation unit 12 creates scenario data, which includes basic data, pre-pitch data, pitch data and results data, and sends that data to the scenario-memory unit 13, and the scenario-memory unit 13 stores the scenario data from the scenario-creation unit 12 (A7). When there is code in the scenario data indicating that it is a special scenario, the special-scenario-creation unit 14 sends CG data corresponding to the code indicating a special scenario to the scenario-memory unit 13 when the scenario data is sent from the scenario-creation unit 12 to the scenario-memory unit 13, and the scenario-memory unit 13 stores the CG data together with the scenario data from the scenario-creation unit 12.

Next, the operation of searching for and distributing scenario data will be explained.

The transmission unit 16 receives search data that is sent from the terminal 20 via the Internet 30 (B1), and transfers the received search data to the scenario-search unit 17.

The scenario-search unit 17 searches for scenario data stored in the scenario-memory unit 13 based on the search data send from the terminal 20 via the Internet 30 (B2), and then determines whether or not the scenario data searched for contains code indicating that it is a special scenario (B3), and when there is code indicating a special scenario, it adds CG data to the searched scenario data (B4), and the transmission unit 16 sends the scenario data and CG data as a set to the terminal 20 (B5). When there is no code indicating a special scenario, the transmission unit 16 sends only the scenario data to the terminal 20 (B5).

Depending on the search data, the scenario data searched for by the scenario-search unit 17 may be complete scenario data (1 game) or partial scenario data, and when the search data specifies a game, the entire scenario data is searched and sent to the terminal 20, and when the search data specifies search conditions such as a player, homerun, etc., that part of the scenario data is searched and sent to the terminal 20.

The terminal 20 that receives the scenario data creates CG based on the received scenario data and stored CG, and reproduces the game. Also, when there is code indicating a special scenario contained in the pre-pitch data, pitch data and results data, the terminal 20 creates CG based on the scenario data and received CG data combined with it, and reproduces the game.

As was explained above, with this embodiment, by expressing the contents of a sports competition or game as CG on a terminal based on scenario data that show the progression of the sports competition, it is possible to reduce the amount of data distributed to the terminal, and it is possible to distribute the contents of a sports competition over the Internet, therefore, it is possible to see the sports competition contents when desired, and because it is possible to search for scenario data, it is possible to look at a desired scene from the sports competition.

Also, in this embodiment the input for creating scenario data can be input while actually watching the competition or game, or can be input based on a scorebook that makes it possible to get grasp of the progression of the competition or game.

In this embodiment, an example of expressing the contents of a sport competition or game on a terminal 20 as CG was explained, however, it is also possible to place photographs or animations showing the contents of the sports competition in the terminal 20 in advance and to sequentially change and display the photographs and animation based on the scenario data that shows the progression of the sport competition or game.

Below, an example of sequentially changing and displaying photos and animation based on scenario data showing the progression of the sports competition will be explained in detail.

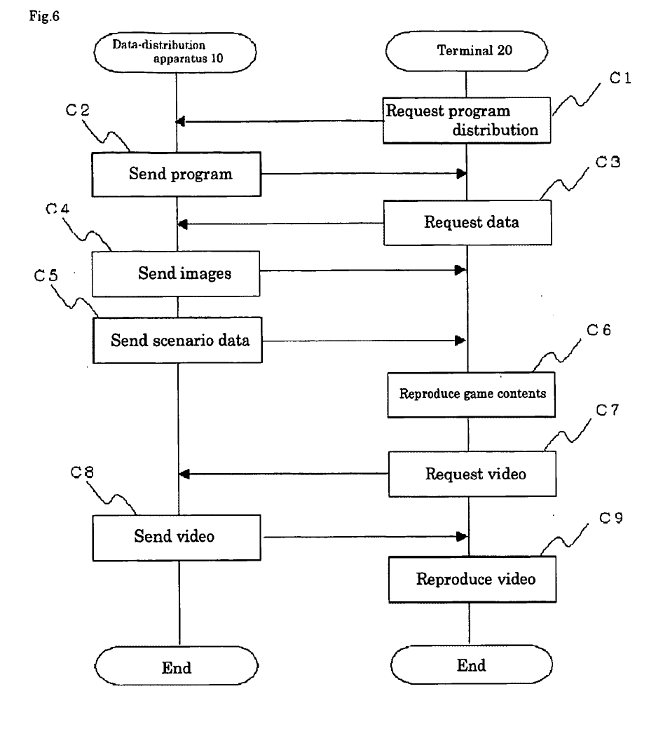

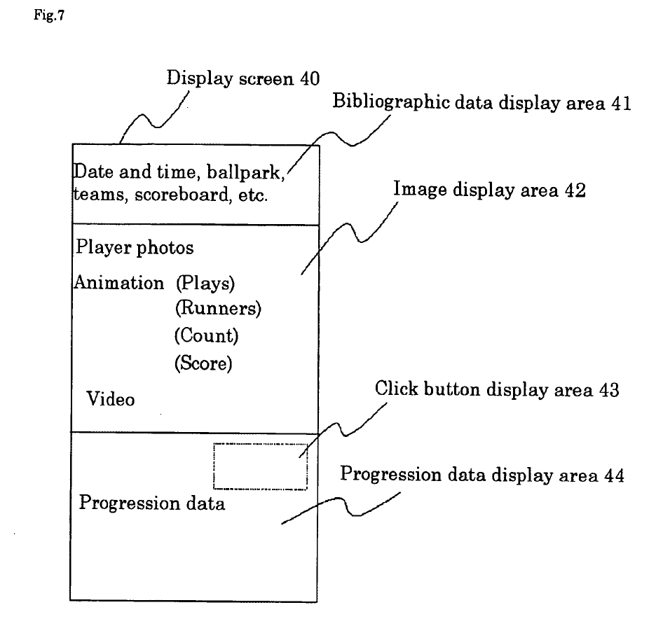

FIG. 6 is a drawing showing the relationship between the data-distribution apparatus and the terminal in an embodiment of the data distribution system of the invention, and FIG. 7 is a drawing showing an example of the display screen that is displayed on the terminal shown in FIG. 1.

First, the terminal 20 sends a request to the data-distribution apparatus 10 to distribute the scenario reproduction program, which is a program for reproducing the scenario data (step C1), and the data-distribution apparatus 10 sends the scenario reproduction program to the terminal 20 (step C2). In the case that the terminal is a portable telephone, sending various requests to the data-distribution apparatus 10 and receiving data from the data-distribution apparatus 10 is performed via the Internet 30 using packets.

Next, the terminal 20 sends a request to the data-distribution apparatus 10 to browse the baseball game (step C3), and the data-distribution apparatus 10 sends images related to the progression of the game and scenario data showing progression of the game (steps V4, V5). The images send from the data-distribution apparatus 10 to the terminal 20 are photos of players, animation showing the play contents (outs, hits, homeruns, etc.), animation showing the status of the runners (first base, second base, etc.), animation showing the count, and animation showing the score, and all or part of this images can be sent from the data-distribution apparatus to the terminal 20 in step C2 together with the program.

Using the scenario reproduction program that was received in advance, terminal 20 reproduces the game contents on the display screen 40 as shown in FIG. 7 based on the received scenario data and images (step C6). The display of the display screen 40 that is created by the scenario reproduction program comprises: a bibliographic data display area 41, an image display area 42, click button display area 43, and progression data display area 44; where bibliographic data such as date, ball-park, competing teams, scoreboard, etc., that are included in scenario data, are displayed in the bibliographic display area 41; images corresponding to the scenario data are sequentially displayed in the image display area 42; click button corresponding to the situation are displayed in the click button display area 43; and progression data for the game, which are included in the scenario data, are displayed in the progression data display area 44.

As click buttons displayed in the click button display area 43, there are click buttons such as a click button for instructing reproduction of video, a click button for skipping the reproduction of video, etc., where the click button for instructing video reproduction is displayed when there is video prepared for a scene in the scenario data. When the click button for instructing reproduction of video is clicked, the terminal 20 sends a video request to the data-distribution apparatus 10 (step C7), then the data-distribution apparatus 10 sends the requested video (step C8), after which the terminal 20 reproduces and plays the received video in the image display area 42 (step C9). The video can also be sent together with the scenario data in step C5. Furthermore, the click button for instructing the reproduction of a video can be such that it is displayed for preset scenes (homerun, fine play, etc.), and videos for preset scenes can also be prepared on the data-distribution apparatus 10 side.

### INDUSTRIAL APPLICABILITY

With the data distribution system and data distribution method of this invention described above, by expressing the contents of a sports competition or game as CG on a terminal based on scenario data that show the progression of a sports competition or game, it becomes possible to reduce the amount of data distributed and it is distribute the contents of the sports competition or game via the Internet, and thus it is possible to watch the sports competition or game contents when desired, and by making it possible to search for scenario data, it is possible watch desired scenes of the sports competition or game.

Explanation of Code Numbers
10 Data-distribution apparatus
11 Input unit
12 Scenario-creation unit
13 Scenario-memory unit
14 Special-scenario-creation unit
15 CG-data-creation unit
16 Transmission unit
17 Scenario-search unit
20 Terminal
30 Internet
40 Display screen
41 Bibliographic data display area
42 Image display area
43 Click button display area
44 Progression data display area

1. A data distribution system that distributes sports competition contents from a data-distribution apparatus to a terminal via a communications network and comprising: a competition-progression-input means of inputting the progression of said sports competition; a scenario-data-creation means of creating scenario data that shows the progression of said sports competition based on input from said competition-progression-input means; a scenario-data-memory means of storing said scenario data created by said scenario-data-creation means; and a scenario-data-distribution means of distributing said scenario data stored in said scenario-data-memory means to a terminal via a communications network; and where said terminal reproduces said sports competition contents as images based on pre-stored image data and said scenario data.

2. The data distribution system of claim 1 wherein said terminal reproduces said sports competition contents as CG based on CG data, which are stored as said pre-stored image data, and said scenario data.

3. The data distribution system of claim 1 or claim 2 further comprising: a special-scenario-data-registration means of registering unimagined conditions as special scenario data in said scenario data; and a special-image-data-creation means of creating image data that correspond to a said special scenario; and wherein said scenario-data-distribution means distributes said image data created by said special-image-data-creation means together with said scenario data when there is a said special scenario when distributing said scenario data.

4. A data distribution method of distributing sports competition contents from a data-distribution apparatus to a terminal via a communications network wherein said data-distribution apparatus creates scenario data showing the progression of the sports competition based on the input progression of said sports competition, stores in memory said created scenario data, and distributes said stored scenario data to said terminal via said communications network, and wherein said terminal reproduces said sports competition contents as images based on pre-stored image data and said scenario data.

5. The data distribution method of claim 4 wherein said terminal reproduces said sports competition contents as CG based on CG data, which are stored as said pre-stored image data, and said scenario data.

6. The data distribution method of claim 4 or claim 5 wherein said data-distribution apparatus registers unimagined conditions as special scenario in said scenario data, creates image data corresponding to said special scenarios, and distributes said created image data together with said scenario data when there is a said special scenario included when distributing said scenario data.

7. A memory medium that stores said scenario data that are distributed by said data distribution system from said data-distribution apparatus to said terminal as described in any of the claims 1 to 3.

8. A data distribution method of distributing the contents of a sports competition that distributes image data related to the progression of said sports competition, scenario data that shows the progression of said sports competition, and a program that sequentially switches and displays said image data according to said scenario data.
